(19) United States
(12) Patent Application Publication
(10) Pub. No.: US 2007/0113269 A1
(43) Pub. Date: May 17, 2007

(54) Controlling access to a network using redirection

(76) Inventor: Junbiao Zhang, Bridgewater, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/566,393

(22) PCT Filed: Jul. 29, 2004
(86) PCT No.: PCT/US04/24559

§ 371 Date: Jan. 27, 2006

Related U.S. Application Data
(60) Provisional application No. 60/490,687, filed on Jul. 29, 2003.

(51) Int. Cl. G06F 17/30

(52) U.S. Cl. 726/4

(57) ABSTRACT

A mechanism to improve the security and access control over a network, such as a wireless local area network (“WLAN”), that takes advantage of web browser interactions without requiring explicit separate communication session between a hot spot network and a service provider network. The method comprises receiving a request to access the WLAN from a mobile terminal (MT)/client disposed within a coverage area of the WLAN. The access point (AP) of the network associates a session ID and randomized number with an identifier associated with the MT and stores data mapping the session ID to the identifier of the MT and randomized number. The local server transmits an authentication request in the form of a web page, which includes the session ID and randomized number, to the MT. The AP receives from the MT a digitally signed authentication message, a parameter list containing user credential information, session ID, and randomized number concerning the MT, the authentication message being digitally signed using the session ID and randomized number together with the parameter list. The AP correlates the session ID and parameter list received from the MT and, using the stored mapping data, generates a local digital signature for comparison with the received digitally signed authentication message for controlling access of the MT to the WLAN.

### FIELD OF THE INVENTION

The invention provides an apparatus and a method to improve the security and access control over a network, such as wireless local area network (“WLAN”), through web browser redirection.

### BACKGROUND OF THE INVENTION

The context of the present invention is the family of wireless local area networks (WLANS) employing the IEEE 802.1x architecture having an access point (AP) that provides access for mobile communications devices (also called “clients” or “client devices”) and to other networks, such as hard wired local area and global networks, such as the Internet. Advancements in WLAN technology have resulted in the publicly accessible hot spots at rest stops, cafes, airports, libraries and similar public facilities. Presently, public WLANs offer mobile communication device (client) users access to a private data network, such as a corporate intranet, or a public data network such as the Internet, peer-to-peer communication and live wireless TV broadcasting. The relatively low cost to implement and operate a public WLAN, as well as the available high bandwidth (usually in excess of 10 Megabits/second) makes the public WLAN an ideal access mechanism through which mobile wireless communications device users can exchange packets with an external entity.

When a mobile user roams into a hotspot network, it may be necessary for the hotspot network and the user's service provider network to carry out a roaming protocol to authenticate the user and grant user access. More particularly, when a user attempts to access service within a public WLAN coverage area, the WLAN first authenticates and authorizes the user, prior to granting network access. After authentication, the public WLAN opens a secure data channel to the mobile communications device to protect the privacy of data passing between the WLAN and the device. Presently, many manufacturers of WLAN equipment have adopted the IEEE 802.1x standard for deployed equipment. Hence, this standard is the predominant authentication mechanism utilized by WLANs. Unfortunately, the IEEE 802.1x standard was designed with private LAN access as its usage model. Hence, the IEEE 802.1x standard does not provide certain features that would improve the security in a public WLAN environment.

FIG. 1 illustrates the relationships among three entities typically involved in an authentication in a public WLAN environment: a user terminal or mobile terminal/mobile communications device/client device (Mr) 140, a WLAN 124 having at least one access point (AP), and the authentication server (AS) 150, which may be associated with a particular service provider, or virtual operator. The trust relationships are as follows: the MT has an account with AS and thus they mutually share a trust relationship 142; the WLAN operator and the operator owning the AS (referred to as “virtual operator” thereafter) have a business relationship, thus the AP or WLAN and the AS have a trust relationship 126. The objective of the authentication procedure is to establish a trust relationship between the MT and the AP by taking advantage of the two existing trust relationships.

In a web browser based authentication method, the MT directly authenticates with the AS, using the web browser through a Hyper Text Transfer Protocol Secured Sockets (HTTPS) protocol and ensures that the AP (and anyone on the path between the Mr and the AS) cannot trespass upon or steal confidential user information. While the channel is secure, the AP cannot determine the result of the authentication unless explicitly notified by the AS. However, the only information the AS has related to the MT is its Internet protocol or IP address at the other end of the HTTPS session. When firewalls, Network Address Translation (NAT) servers, or web proxies are electronically situated between the AS and the MT, which is normally the case with the virtual operator configuration, it is difficult or even impossible for the AS to initiate a session to notify the AP about the authentication result of the authentication and to identify the MT.

Most existing WLAN hot spot wireless providers use a web browser based solution for user authentication and access control, which proves convenient to the user and does not require any software download on the user device. In such a solution, the user is securely authenticated through HTTPS by a server, which in turn notifies the wireless AP to grant access to the user. Such an authentication server AS may be owned by the WLAN operator or any third party providers, such as Independent Service Providers (ISPs), pre-paid card providers or cellular operators, referred to more broadly as virtual operators.

In the prior art, the authentication is achieved through a communication between the user and the authentication server, through a secure tunnel. As such the AP does not translate the communication between the user and the authentication server. Consequently, a separate communication referred to as authorization information between the AP and the authentication server AS must be established so that the AP is notified of the authorization information.

Access control in the AP is based on the address of the mobile communications device/client device, where the addresses may be physical addresses (PHY), MAC addresses or IP addresses, and therefore, the authentication server AS can use the mobile terminal MT IP address (the source address of the HTTPS tunnel) as the identifier when it returns the authentication result to the AP. This approach succeeds, if neither a firewall nor a NAT between the AP and the authentication server AS exists, such as illustrated by firewall FW and the local server LS. In general and when virtual operators are present (e.g. when roaming is involved), the authentication server is located outside of the wireless access network domain, and thus outside of the firewall FW, and often the HTTPS connection used for authentication actually goes through a web proxy as shown in FIG. 2. The source address that the authentication server AS receives would be the web proxy's address, which cannot be used to identify the mobile terminal Mr user device and, therefore, cannot be used by the AP in assuring a secure connection.

PU030050, Junbiao Zhang, Saurabh Mathur, Kumar Ramaswamy, “TECHNIQUE FOR SECURE WIRELESS LAN ACCESS” U.S. application Ser. No. 10/424,442, filed Apr. 28, 2003, describes a general technique of web browser based secure WLAN access solution in hop spot.

PU030071, Junbiao Zhang, “An identity mapping mechanism in WLAN access control with public authentication serves” U.S. Provisional Ser. No. 60/453,329, addresses the same issue as this invention and uses a separate secure communication session between the hot spot network and the service provider network that is initiated by the hot spot network. Thus two separate secure sessions need to be maintained.

What is needed is a mechanism for improving the security and access control over a network such as a wireless local area network (“WLAN”) that takes advantage of web browser interactions without requiring an explicit separate communication session between a hot spot network and a service provider network.

### SUMMARY OF THE INVENTION

A method for controlling access to a network includes a mobile terminal and an access point for relaying network communications to and from the mobile terminal, and an authentication server for performing an authentication process in response to a request from the mobile terminal. The method comprises at the access point, receiving a request to access the network from a mobile terminal, associating unique data with an identifier of the mobile terminal and storing a mapping of the association. The unique data is transmitted to the mobile terminal for use in authenticating the mobile terminal via an authentication server. At the authentication server, the step of authenticating the mobile terminal is performed using the unique data, and upon authentication, redirecting a success code to the mobile terminal, including a digitally signed authentication message and authentication parameters corresponding to the unique data, using a re-direct header. The access point receives the digitally signed retrieved re-directed URL and authentication parameters from the mobile terminal and correlates the authentication parameters with the mapped association data for determining access to the network.

According to another aspect, a system for controlling access to a network comprises a mobile terminal, an access point coupled to a local server for relaying network communications to and from the client, and an authentication server for performing an authentication process in response to a request from the client. The local server in response to a re-directed request to access the network from the client, associates unique data with an identifier of the mobile terminal, stores a mapping of the association, and transmits the unique data to the client for use in authenticating the client via the authentication server. The authentication server, upon authenticating the client using the unique data, is operative to provide a re-direct header for access to the client including a digitally signed authentication message and authentication parameters corresponding to the unique data, the AP receiving the digitally signed retrieved re-directed URL and authentication parameters from the client and correlating the authentication parameters with the mapped association data for determining access to the network based on the results of the correlation.

### BRIEF DESCRIPTION OF THE DRAWINGS

The invention is best understood from the following detailed description when read in connection with the accompanying drawings. The various features of the drawings are not specified exhaustively. On the contrary, the various features may be arbitrarily expanded or reduced for clarity. Included in the drawings are the following figures:

FIG. 1 is a block diagram of a communications system for practicing the method of the present principles for authenticating a mobile wireless communications device.

FIG. 2 is a block diagram of the communications system where the authentication server is behind a firewall.

FIG. 3 is a message exchange diagram depicting the operation of the present invention.

### DETAILED DESCRIPTION OF THE INVENTION

In the figures to be discussed, the circuits and associated blocks and arrows represent functions of the method according to the present invention, which may be implemented as electrical circuits and associated wires or data busses, which transport electrical signals. Alternatively, one or more associated arrows may represent communication (e.g., data flow) between software routines, particularly when the present method or apparatus of the present invention is implemented as a digital process.

In accordance with FIG. 2, one or more mobile terminals represented by MT 140 communicate through a WLAN access point AP and associated computers 120 (e.g. local servers) in order to obtain access to a network and associated peripheral devices, such as a database coupled to the network. There is at least one access point. The AP and the local server may be co-located and/or a single unit may perform the functions of both the AP and the local server. The MT communicates with an authentication server 150 for securing access and authentication to the network. It should be understood that the principles embodying the present invention, though described herein with respect to a wireless network such as a WLAN, may nevertheless find application to any access network, whether wired or wireless.

As further illustrated in FIG. 2, the IEEE 802.1x architecture encompasses several components and services that interact to provide station mobility transparent to the higher layers of a network stack. The IEEE 802.1x network defines AP stations such as access point 130 and one or more mobile terminals 140 as the components that connect to the wireless medium and contain the functionality of the IEEE 802.1x protocols, that being MAC (Medium Access Control) and corresponding PHY (Physical Layer) (not shown), and a connection 127 to the wireless media. Typically, the IEEE 802.1x functions are implemented in the hardware and software of a wireless modem or a network access or interface card. This invention proposes a method for implementing an identification means in the communication stream such that an access point 130 compatible with the IEEE 802.1x WLAN MAC layers for downlink traffic (i.e. from the authentication server to the mobile terminal such as a laptop) may participate in the authentication of one or more wireless mobile communications devices/client devices 140 a local server 120 and a virtual operator, which includes an authentication server 150.

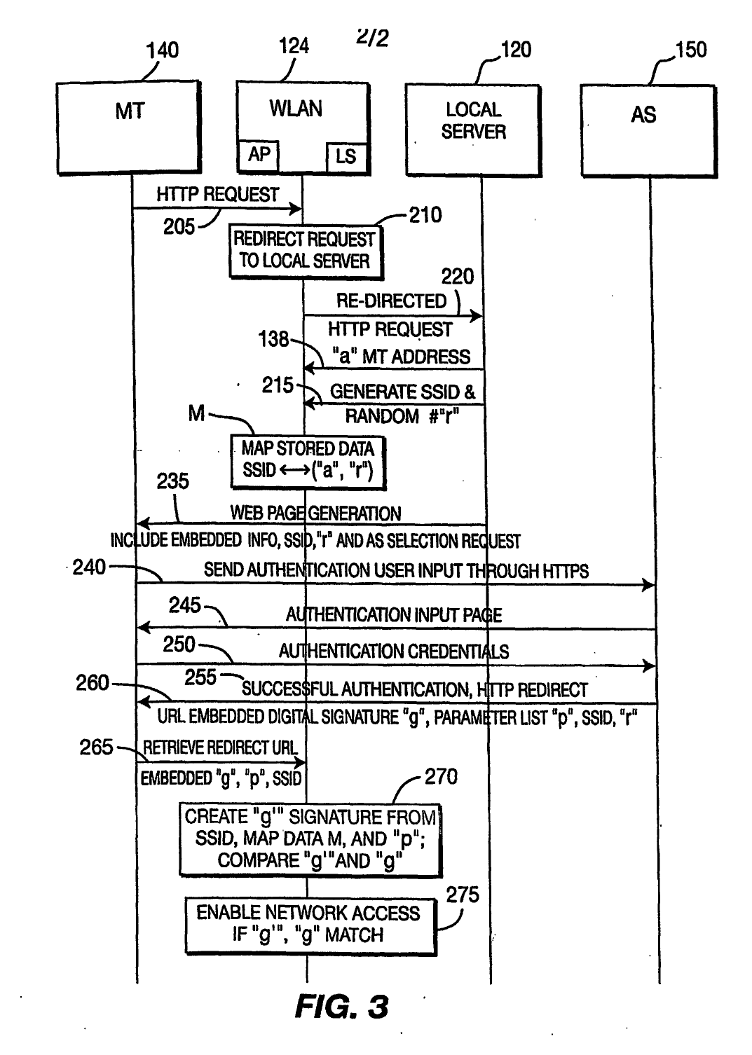

With reference now to FIG. 3, a method in accordance with the present invention for improving the security of a mobile terminal 140 in a WLAN 124 is generally accomplished by redirecting 210 a HTTP browser request 205 to a local server 120 via message 220. The method of the present invention includes embedding a session ID 215 and randomized number in a user input request to the mobile terminal, inside the HTTP request 205, authenticating the mobile terminal and including digital signature information along with the session ID and randomized number within a redirect request to retrieve data from the WLAN, whereby the AP performs a matching of the-digital signature information received from the MT with a locally generated digital signature based on stored mapping data, to determine access to the WLAN.

More particularly, the method of the present invention processes an access request from a mobile terminal 140 through the WLAN 124, access point 130 (web request 205 from the mobile terminal 140), by embedding in a network address location such as a Uniform Resource Locator (URL) the session D 215 and randomized number associated with an identifier of the mobile terminal.

The address of the client/MT is obtained from the {client, AP} 138 and the local server then generates unique data 215, which may include a session ID and a randomized number. The unique data is forwarded to the AP by the local server where an association mapping is made between the unique data and an identifier of the MT/client. The MT/client identifier is the client/MT address and may be the physical address (PHY), the MAC address or the IP address of the MT/client. The association mapping is stored in the AP.

The local server then generates a Web page 235 and transmits/forwards the generated Web page to the MT/client including embedded information and a request for the MT/client to select an AS. The embedded information may include the unique data.

Upon receipt of the Web page, the Mr/client transmits an authentication user input message 240 including the session ID to the AS. The AS responds by sending the MT/client an authentication input page 245 requesting authentication information from the MT/client. The MT/client responds to the authentication input request by supplying its credentials to the AS 250. Once the AS authenticates the MT/client, an authentication message 255, including a re-direct header is sent to the Mr/client. The authentication message may also include an embedded digital signature, authentication parameters and at least a portion of the unique data.

The MT/client responds to the authentication message by retrieving and forwarding the re-directed URL 265, including the embedded digital signature, authentication parameters and session ID, to the AP. The AP creates a local digital signature 270 using the embedded information from the retrieved re-directed URL and the associated mapping and then performs a comparison between the locally generated digital signature and the digital signature generated by the AS. If there is a match between the two digital signatures then network access is granted 275. If there is no match between the two digital signatures then network access is denied.

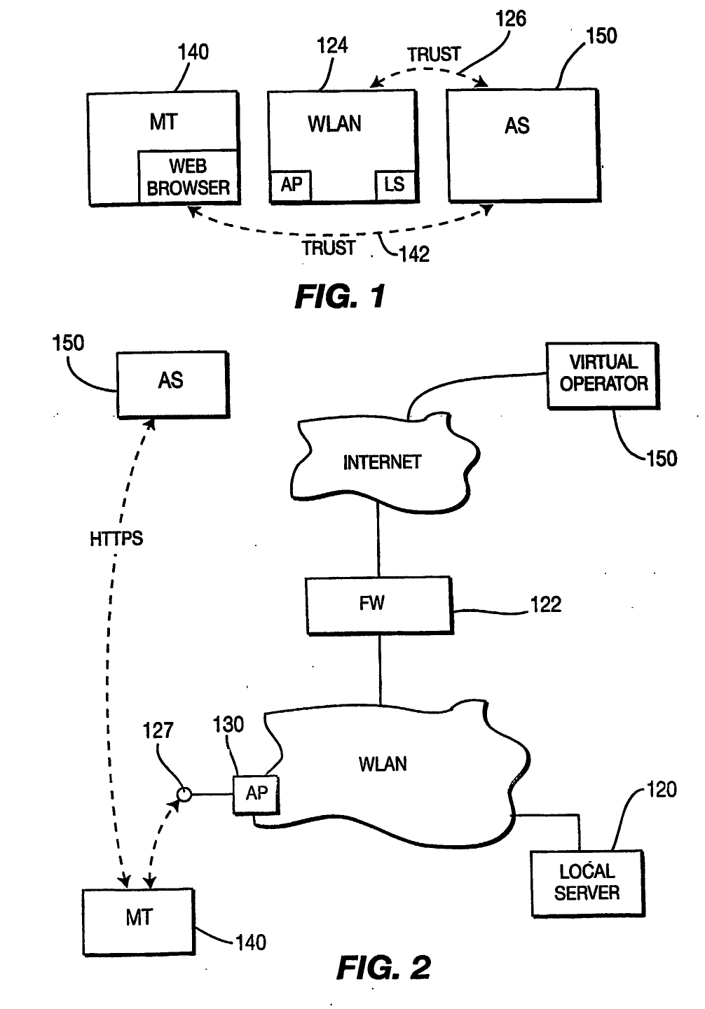

According to an aspect of the invention, with reference to FIG. 3 (in conjunction with the system of FIGS. 1 and 2), a method in accordance with the present invention for improving the security of a mobile terminal 140 in a WLAN environment 124 (e.g. public hot spot) redirects 210 the mobile user's browser request 205 to the local web server 120 of WLAN 124. The local server 120 receives the redirected browser request 220 and obtains an identifier (a) such as the MAC address 138 “a” associated with the mobile terminal 140, and generates a unique session ID (SID) 215 along with a randomized number “r”. Note that the term randomized number as used herein includes any random numbers, pseudo-random numbers or other such numbers generated in a manner so as to provide at least a minimal degree of randomness. Various mechanisms are known to exist for generating such numbers, the details of which are omitted here for brevity.

The WLAN 124 maintains a mapping between the session ID 215, MAC address 138 “a” and randomized number “r” of the mobile terminal 140, and stores a mapping M associating the session ID 215, the MAC address 138 “a” and the randomized number “r” in memory (e.g. lookup table, cache, RAM, flat files etc.) The address acts as an identifier for the client and may be a physical address WHY), a MAC address or an IP address. In one configuration, the local server 120 generates a web page 235, requesting a user of the mobile terminal 140 to select a virtual operator and embedding the session ID 215 and randomized number “r” into web page 235 for transmission. This may be accomplished, for example, by embedding the session id and randomized number “r” in the URL address associated with the submit button to initiate the HTTPS session with the authentication server 150.

After the web page 235 is sent to the MT, the user makes an appropriate selection of an authentication server, and an authentication request 240 is sent having user input including the session ID (SID) 215 and randomized number “r” embedded in the request, through HTTPS to the selected authentication server 150. More particularly, the mobile terminal responds by embedding the URL associated with a submit button to start an HTTPS session with an authentication server 150, whereby the MT sends the authentication request 240 having the session ID 215 embedded in the request, through HTTPS to the authentication server 150.

In response, the authentication server 150 processes the request and communicates to the MT an authentication input page 245 requesting authentication information. The user then inputs certain authentication parameters or credentials 250 (e.g. user name and password) and submits them to the authentication server 150 through HTTPS.

The authentication server then receives the authentication credentials 250 from the MT and authenticates the user based on the received information and the trust relationship with the MT. The authentication server then generates a success code 255 including associated information (e.g. authentication information) relevant to MT access. This information is provided as a parameter list “p” for the access network or WLAN. The parameter list “p” together with the randomized number “r” and session id 215 are then put together (e.g. concatenated, juxtaposed or otherwise combined) and digitally signed by the AS. Such digital signature may be accomplished, for example, by using the authentication server's private key or with a shared key or hash between the authentication server and the WLAN. The resulting digital signature from the AS is denoted as “g”.

The AS then returns an HTTP redirect header 260 to the MT to redirect the user browser to a URL on the AP WLAN. The parameter list “p”, session id SID and digital signature “g” are embedded in the URL from the AS and sent to the Mr. In one configuration, the redirection header can be an actual HTTP header. In another configuration, the redirection header may be an “HTTP-EQUIV” directive in the returned HTML page.

In response to the HTTP redirection, the user browser MT attempts to retrieve the redirected URL 265 with the MT sending the parameter list “p”, SID 215, and digital signature “g” to the WLAN 124. In response to the received information (re-directed URL) 265 from the Mr, the WLAN then retrieves the randomized number “r” and the identifier “a” from the stored mapping data using the SID from the stored mapping data. More particularly, the local server 120 receives the SID sent in the redirected URL request from the Mr, and uses the received SID along with the mapped stored data M, which also contains the SID to determine the corresponding randomized number “r” and address or mobile communications device identifier “a”. The WLAN then puts the received parameter list “p” from the MT together with the randomized number “r” retrieved from the stored mapping data and the SID following the same method that was used by the AS in generating digital signature “g”, in order to generate its own digital signature “g” (270). The WLAN then compares the digital signatures “g” and “g”. The parameter list “p” will be accepted and access to the WLAN enabled only if it is determined that “g” and “g” are the same (275). Various actions such as changing traffic filtering rules can then be taken with respect to the MT address identifier “a”. The above-described access control mechanism enables authentication and network access for a mobile terminal without the need for maintaining two (or more) separate secure communications sessions.

It is to be understood that the form of this invention as shown is merely a preferred embodiment. For example, while the embodiments described refer to a WLAN access system, the aforementioned system and method is applicable for any access network, whether wired or wireless. Further, it is understood that the subject invention may reside in the program storage medium that constrains operation of the associated processors(s), and in the method steps that are undertaken by cooperative operation of the processor(s) on the messages within the communications network. These processes may exist in a variety of forms having elements that are more or less active or passive. For example, they exist as software program(s) comprised of program instructions in source code or object code, executable code or other formats. Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through the Internet or other networks. Examples of the foregoing include distribution of the program(s) on a CD ROM or via Internet download.

The same is true of computer networks in general. In the form of processes and apparatus implemented by digital processors, the associated programming medium and computer program code is loaded into and executed by a processor, or may be referenced by a processor that is otherwise programmed, so as to constrain operations of the processor and/or other peripheral elements that cooperate with the processor. Due to such programming, the processor or computer becomes an apparatus that practices the method of the invention as well as an embodiment thereof. When implemented on a general-purpose processor, the computer program code segments configure the processor to create specific logic circuits. Such variations in the nature of the program carrying medium, and in the different configurations by which computational and control and switching elements can be coupled operationally, are all within the scope of the present invention.

Various other changes may be made in the function and arrangement of parts; equivalent means may be substituted for those illustrated and described; and certain features may be used independently from others without departing from the spirit and scope of the invention as defined in the following claims.

1. A method for controlling access to a network, said method comprising:
receiving, by an access point (AP) of said network, a request to access said network, said request transmitted by a client;
re-directing, by said AP, said access request to a local server;
associating unique data with an identifier of said client and storing a mapping of said association in said AP;
generating a Web page by said local server requesting that said client select an authentication server (AS) and including said unique data and forwarding said generated Web page to said client;
transmitting an authentication request to said selected authentication server; and
receiving a response to said authentication request from said selected authentication server.

2. The method according to claim 1, wherein said network is a wireless Local Area network (WLAN).

3. The method according to claim 1, further comprising:
forwarding said identifier of said client from said local server; and
generating said unique data for said client by said local server.

4. The method according to claim 1, further comprising:
retrieving, by said client, a re-directed URL having embedded data including a first digital signature, authentication parameters and said unique data and forwarding said re-directed URL to said AP;
creating, by said AP, a second digital signature using said authentication parameters, said unique data and said identifier;
comparing, by said AP, said first digital signature with said second digital signature;
determining, by said AP, if there is a match between said first digital signature and said second digital signature; and
performing, by said AP, one of granting network access and denying network access based on said match determination.

5. The method according to claim 1, wherein said unique data includes a session ID and a randomized number.

6. The method according to claim 1, wherein said identifier is an address of said client.

7. The method according to claim 1, wherein the act of authenticating further comprises:
processing, by said AS, said authentication request, wherein said authentication request includes a session ID embedded in said authentication request;
responding to said authentication request by forwarding to said client by said AS an authentication input page, said authentication input page including a request for authentication information; and
receiving, by said AS, authentication credentials from said client, wherein said response to said authentication request forwarded to said client includes a re-direct header and a success code and associated information relevant to access of said network by said client.

8. The method according to claim 7, wherein the act of forwarding further comprises generating, by said AS, said success code and said associated information includes a first digital signature and authentication parameters.

9. The method according to claim 5, wherein said randomized number is one of a random number and a pseudo-random number.

10. The method according to claim 1, wherein said identifier is one of a physical (PHY) address of said client, a MAC address of said client and an IP address of said client.

11. The method according to claim 1, wherein said AP and said local server are co-located.

12. The method according to claim 4, wherein said first and said second digital signatures are generated using one of a private key of said AS and a shared key between said AS and said local server.

13. The method according to claim 4, wherein said second digital signature is locally generated at said AP.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A system for controlling access to a network comprising:
a client;
an access point (AP) coupled to a local server (LS) for relaying network communications to and from the client; and
an authentication server for performing an authentication process in response to a request from the client; wherein
the AP, in response to a re-directed request to access the network from the client, associates unique data with an identifier of the client and stores a mapping of the association;
the LS transmits the unique data to the client;
the authentication server, upon authenticating the client using the unique data, is operative to provide a re-direct header for access to the client including a digitally signed authentication message and authentication parameters corresponding to the unique data, the AP receiving the digitally signed retrieved re-directed URL and authentication parameters from the client and the AP further correlating the authentication parameters with the mapped association data for determining access to the network based on the results of the correlation.

26. The system of claim 25, wherein the network is a wireless local area network (WLAN) comprising the access point and local server.

27. The system of claim 25, wherein the local server generates a web page requesting that the client select an authentication server, and embeds the unique data in the web page for transmission to the client.

28. The system of claim 25, wherein the identifier of the client is one of a physical address, MAC address and an IP address, and wherein the unique data comprises a session ID and a randomized number.

29. The system of claim 28, wherein the session ID and randomized number are generated by the local server.

30. The system of claim 28, wherein the authentication server receives user credential information from the client and provides a digitally signed authentication message including an authentication parameters using said unique data through HTTPS to the client via said re-direct header to the client.

31. The system of claim 30, wherein the AP, in response to receiving the digitally signed authentication message re-directed from the client including the authentication parameters and at least a portion of the unique data from the client, generates a local digital signature using the received portion of the unique data and the stored mapping data together with the authentication parameters, and compares the local digital signature with the digitally signed authentication message to determine network access by the client.

32. The system of claim 25, wherein the re-direct header further comprises a means for re-directing a browser of the client to a URL on the network, and embedding in the URL said digitally signed authentication message, the authentication parameters and a portion of the unique data.

33. The system of claim 26, wherein said AP and said LS are co-located.

34. The method of claim 1, further comprising:
at the authentication server, authenticating the client using the unique data, and forwarding said response to the client using a re-direct header, and including a digitally signed authentication message and authentication parameters corresponding to the unique data; and
the access point receiving from the client according to the re-direct header the digitally signed authentication message and authentication parameters and correlating the authentication parameters with the mapped association data for determining access to the network.

35. (canceled)

36. The method of claim 1, wherein said unique data comprises a session ID and a randomized number and further comprising: receiving, by said AP, a re-directed request from the client and including a digitally signed authentication message, an authentication parameter list, and said session ID, the digitally signed authentication message being generated using the randomized number, said session ID and said authentication parameter list, by said selected authentication server associated with the client; and
correlating the received digitally signed authentication message with the re-directed request for access using the stored mapping data for controlling access by the client to the network.

37. (canceled)

38. (canceled)

39. (canceled)

40. (canceled)

41. The method according to claim 36, wherein said AP and said LS are co-located.

42. A method for controlling network access, said method comprising:
receiving a request for network access;
re-directing said request via a message;
receiving a client identifier and unique data;
associating said unique data and said client identifier;
receiving a re-directed universal resource locator included embedded information;
generating a local digital signature using said embedded information and said association between said unique data and said client identifier;
comparing said local digital signature with a digital signature received in said embedded information;
granting network access if said local digital signature matches said digital signature received in said embedded information; and
deny network access if said local digital signature does not match said digital signature received in said embedded information.

43. The method according to claim 42, wherein said unique data comprises a session identifier and a random number.

44. The method according to claim 42, wherein said embedded information further comprises a session identifier and authentication parameters.

45. A system for controlling network access, comprising:
means for receiving a request for network access;
means for re-directing said request via a message;
means for receiving a client identifier and unique data;
means for associating said unique data and said client identifier;
means for receiving a re-directed universal resource locator included embedded information;
means for generating a local digital signature using said embedded information and said association between said unique data and said client identifier;
means for comparing said local digital signature with a digital signature received in said embedded information;
means for granting network access if said local digital signature matches said digital signature received in said embedded information; and
means for deny network access if said local digital signature does not match said digital signature received in said embedded information.

46. The system according to claim 45, wherein said unique data comprises a session identifier and a random number.

47. The system according to claim 45, wherein said embedded information further comprises a session identifier and authentication parameters.

48. A method for controlling network access, said method comprising:
receiving a re-directed request for network access via a message;
transmitting a client identifier and unique data; and
generating a web page including embedded data.

49. The method according to claim 48, wherein said unique data comprises a session identifier and a random number.

50. The method according to claim 48, wherein said embedded data comprises a session identifier, a random number and authentication server selection information.

51. A system for controlling network access, comprising:
means for receiving a re-directed request for network access via a message;
means for transmitting a client identifier and unique data; and
means for generating a web page including embedded data.

52. The system according to claim 5 1, wherein said unique data comprises a session identifier and a random number.

53. The system according to claim 51, wherein said embedded data comprises a session identifier, a random number and authentication server selection information.

54. A method for controlling network access, said method comprising:
receiving an authentication user input message;
transmitting authentication input page requesting authentication information;
receiving authentication credentials; and
transmitting an authentication message indicating one of success and failure of an authentication process.

55. The method according to claim 54, wherein said authentication message comprises a digital signature, a session identifier, authentication parameters and a random number.

56. A system for controlling network access, comprising:
means for receiving an authentication user input message;
means for transmitting authentication input page requesting authentication information;
means for receiving authentication credentials; and
means for transmitting an authentication message indicating one of success and failure of an authentication process.

57. The system according to claim 56, wherein said authentication message comprises a digital signature, a session identifier, authentication parameters and a random number.
